(19) United States
(12) Patent Application Publication
(10) Pub. No.: US 2007/0126232 A1
(43) Pub. Date: Jun. 7, 2007

(54) Fluid coupling with non-protective coated endform tip

(75) Inventors: Guido M. Campagna, Farmington Hills, MI (US); Timothy J. Stuart, Lapeer, MI (US); Randy W. Krause, Dryden, MI (US); Darrell Wilczynski, Oxford, MI (US)

Correspondence Address: YOUNG & BASILE, P.C., 3001 WEST BIG BEAVER ROAD, SUITE 624, TROY, MI, 48084, US

(73) Assignee: ITT Manufacturing Enterprises, Inc., Wilmington, DE (US)

(21) Appl. No.: 11/294,148

(22) Filed: Dec. 5, 2005

(51) Int. Cl. F16L 39/00

(52) U.S. Cl. 285/319

(57) ABSTRACT

A fluid coupling includes a housing having a seal mounted in a bore. An endform has a tip portion extending from a tip end and a retainer engagement surface which is engaged by a retainer movable in the housing to latch the endform to the housing. A protective layer is disposed on an exterior surface of the endform extending from an end spaced from the tip end of the endform and defining a bare exterior surface on the tip portion of the endform which is directly engaged by the seal.

### BACKGROUND

The present invention relates, in general, to fluid quick connectors which couple fluid carrying or operative components.

Snap-fit or quick connectors are employed in a wide range of applications, particularly, for joining fluid carrying conduits in automotive and industrial application. Such quick connectors utilize retainers or locking elements for securing one connector component, such as a tubular conduit, within a complimentary bore of another connector component or housing. Such retainers are typically of either the axially-displaceable or radially-displaceable type. The terms “axially-displaceable” or “radially-displaceable” are taken relative to the axial bore through the connector housing or body.

In a typical quick connector with an axially displaceable retainer, the retainer is mounted within a bore in a housing of one connector component. The retainer has a plurality of radially and angularly extending legs which extend inwardly toward the axial center line of the bore in the housing. A tube to be sealingly mounted in the bore in the connector housing includes a radially upset portion or flange which abuts an inner peripheral surface of the retainer legs. Seal and spacer members as well as a bearing or top hat are typically mounted in the bore ahead of the retainer to form a seal between the housing and the tube when the tube is lockingly engaged with the retainer legs in the housing.

Radially displaceable retainers are also known in which the retainer is radially displaceable through aligned bores or apertures formed transversely to the main throughbore in the connector housing. The radially displaceable retainer is typically provided with a pair of depending legs which are sized and positioned to slip behind the radially upset portion or flange on the tube or conduit only when the conduit is fully seated in the bore in the housing. This ensures a positive locking engagement of the conduit in the housing as well as providing an indication that the conduit is fully seated since the radially displaceable retainer can be fully inserted into the housing only when the conduit has been fully inserted into the bore in the housing.

Regardless of the type of retainer, the housing portion of a fluid connector typically includes an elongated stem having one or more annular barbs spaced from a first end. The barbs provide secure engagement with a hose or conduit which is forced over the barbs to connect the connector housing with one end of the hose or conduit.

In certain fluid flow applications, such as vehicle fuel delivery systems, the fast flowing fuel creates a static electric charge which must be dissipated to minimize the danger of explosion. Multi-layer tubes containing an internal electrically conductive layer have been provided for conducting any static charge buildup to an electrical ground connection to thereby dissipate the static charge. In such applications, the housing of quick connectors have been formed with conductive materials to complete a static charge conductive path between the conductive layer in the multi-layer tube connected to one end of the housing and the typically metal or conductive plastic endform or conduit inserted into the other end of the connector housing.

In the automotive industry, it is typical for manufacturers to coat or apply corrosive resistant polymeric layers or coatings over the exposed portions of the endform or conduit, particularly in high-pressure fluid applications, such as brake tubes. The polymeric material on the outer surfaces of the fluid conduits and endform greatly enhances the corrosion resistance of the metal tubing used to form the conduit. Thus, conduit manufacturers, especially when the end use will be underneath a vehicle body, do not want to remove any more of the corrosion resistance-enhancing polymeric material than is necessary for connection purposes. Typically, 1-2 mm of the polymeric coating over the inward turned tip end of the endform or conduit is removed to enable direct or surface to surface contact between the tip end of the metal endform and the surrounding housing of the quick connector.

However, in a fluid quick connector having a typical axial or transversely movable retainer, the one or more spacer elements, such as O-rings, a rigid spacer or washer, and the bushing or top hat used to retain the sealing element in the housing bore are disposed in contact with the corrosion-resistant coating on the endform when the endform is latched in the connector housing. This forms the fluid seal between the connector housing and the conduit or endform at the interface between the resilient, seal elements and the polymeric coating on the endform of the conduit. It is possible for a leak path to form between the exterior surface of the metallic conduit and the polymeric coating on the endform which could lead to an unacceptable leak from the fluid connector.

Thus, it would be desirable to provide a fluid coupling which addresses these problems found in prior art fluid couplings using snap together fluid quick connectors and metallic endforms or conduits with corrosion-resistant protective coatings.

### SUMMARY

The present invention is a fluid coupling including a housing having a bore extending from one end, a seal mounted in the bore, an endform having a tip portion extending from a tip end and a retainer engagement surface spaced from the tip end, a retainer movable with respect to the housing into engagement with the retainer engagement surface on the endform to latch the endform to the housing, and a protective layer on an exterior surface of the endform extending from an end spaced from the tip end of the endform and defining a bare exterior surface on the tip portion of the endform, whereby the exterior metal surface of the endform directly contacts the seal in the bore in the housing.

In one aspect, the tip portion of the endform has a first portion devoid of the protective layer formed with a first outer diameter, and a second portion, extending axially from the first portion and having a smaller second outer diameter.

A transition surface may be formed on the endform at the juncture of the first and second portions of the tip portion of the endform.

The protective layer may be formed on the exterior surface of the endform with the end of the protective layer contiguous with the transition surface and the protective layer disposed over the outer diameter of the second tip portion.

The outer diameter of the protective layer is substantially identical to the first outer diameter of the first tip portion.

In one aspect, the seal is a resilient seal member. The seal may also include at least one resilient seal member and a rigid seal member, both disposed in direct contact with the non-protective layer portion of the endform.

The seal may also include a pair of spaced resilient seal members and a rigid seal member disposed between the pair of seal members, all of the seal members disposed in contact with the first tip portion of the endform devoid of the protective layer.

The present fluid coupling provides an enhanced seal in a fluid coupling between a metal endform and a connector housing by providing direct contact between the seal elements of the coupling, the connector housing, and the metal endform without the presence of an intervening corrosion resistant protective layer carried on the adjacent portion of the endform.

### BRIEF DESCRIPTION OF THE DRAWING

The various features, advantages and other uses of the present invention will become more apparent by referring to the following detailed description and drawing in which:

FIG. 1 is an exploded, perspective view of a fluid quick connector used in a fluid coupling;

FIG. 2 is an enlarged, left end, perspective view of the retainer shown in FIG. 1;

FIG. 3 is an end view of the quick connector and retainer, with the retainer shown in a partially inserted, storage position;

FIG. 4 is an end view of the quick connector and he retainer, with the retainer depicted in a fully inserted, position in the quick connector;

FIG. 5 is a cross sectional view generally taken along line 5-5 in FIG. 4; and

FIG. 6 is an enlarged cross sectional view of a portion of the quick connector and retainer shown in FIG. 5.

### DETAILED DESCRIPTION

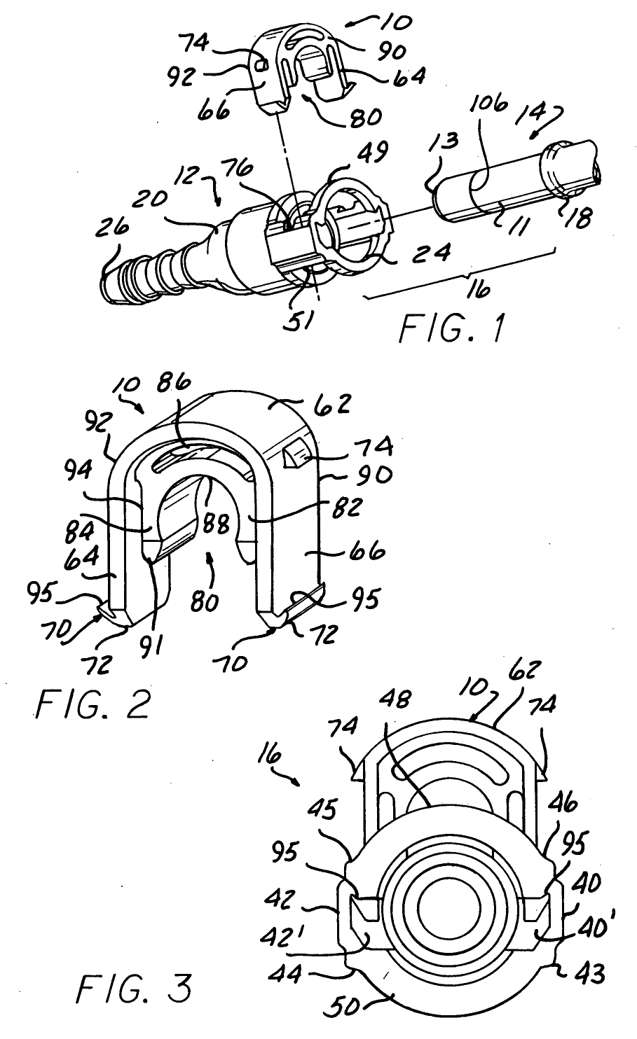

For clarity in understanding the use and operation of the present invention, reference will first be had to FIGS. 1-5 which depict a retainer 10 which lockingly couples first quick connector component 12 and a second fluid component 14 of a fluid coupling 16.

The following description of the first fluid connector component or element 12 is by way of example only as the first connector component 12 may have any suitable shape typically found in quick connectors.

Further, the following description of a fluid coupling making use of the fluid quick connector to connect tubular members will be understood to apply to the connection of conduits, hoses, and/or solid metal or plastic tubes to each other in fluid flow communication. The end of a conduit or tubular member inserted into the interior of one end of the quick connect is defined as an endform. The endform can be a separate member which receives a separate hose or conduit at one end or a shape integrally formed on the end of an elongated metal or plastic tube. Further, the endform can be integrally formed on or mounted as a separate element to a fluid use device, such as a pump, filter, etc., rather than as part of an elongated conduit.

The present fluid coupling finds advantageous use with tubular members, such as conduits, tubes, or hoses which are capable of defining a continuous electrically conductive path through the tubular member itself or through a conductive layer or portion of the tubular member. For example, conductive layers have been provided in multi-layer tubes as disclosed in U.S. Pat. Nos. 5,524,673, and 5,743,304. Reference is made to these conductive layers which provide an electrically conductive path from the quick connector of the present invention to a remote electrical ground to dissipate static electric charges which can build up within the fuel system due to fast flowing fluids, such as vehicle fuels. It will be understood, however, that the present fluid coupling may also be equally, advantageously employed in non-conductive connector applications.

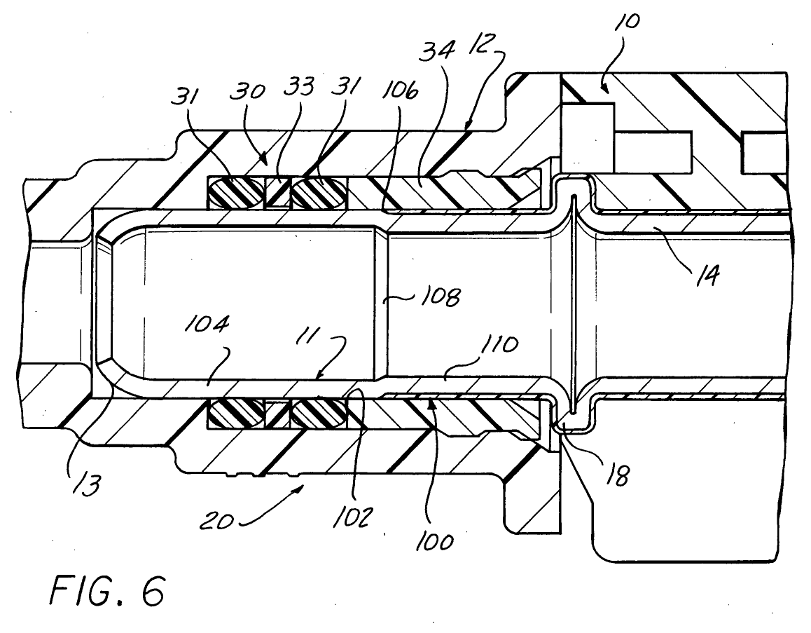

The first connector component 12 includes a housing 20 having an elongated, axially extending, internal stepped bore 22, shown in detail in FIGS. 5 and 6, extending from a large diameter first, open end 24 to a smaller diameter, second open end 26. The stepped bore 22 includes a first bore portion 21 extending from an opening at the first end 24 of the housing 20 to a second smaller diameter second stepped bore portion 23. A third yet smaller diameter stepped bore portion 25 extends axially from one end of the second stepped bore portion 23 and communicates to a still smaller fourth stepped bore portion 27 which extends to the open second end 26 of the housing 20.

As is conventional, a top hat or bearing 34 is mounted in the second stepped bore portion 23 immediately adjacent the end of the first bore portion 21. A seal means 30 is also mounted in the second stepped bore portion 23 between one end of the top hat 34 and the third stepped bore portion 25.

The inner diameter of the first stepped bore portion 21 is sized to slidably receive the outer diameter of a radially enlarged flange or upset bead 18 formed on the second component or endform 14. Further, the inner diameters of the seal means 30 are sized to sealingly engage the outer diameter of the end portion 11 of the second component 14 extending from the radially enlarged flange 18 to the tip end 13 of the second component 14. The third stepped bore portion 25 has an inner diameter sized to snugly engage the outer diameter of the end portion 11 of the second component 14 when the second component 14 is fully inserted into the stepped bore 22 as described hereafter.

The seal means 30 may be formed, by example, of at least one and, preferably, two O-rings 31 which are separated by a rigid, annular spacer 33. The seal means 30 may also be formed of a single seal element, such as an elongated cylindrical or labyrinth-seal.

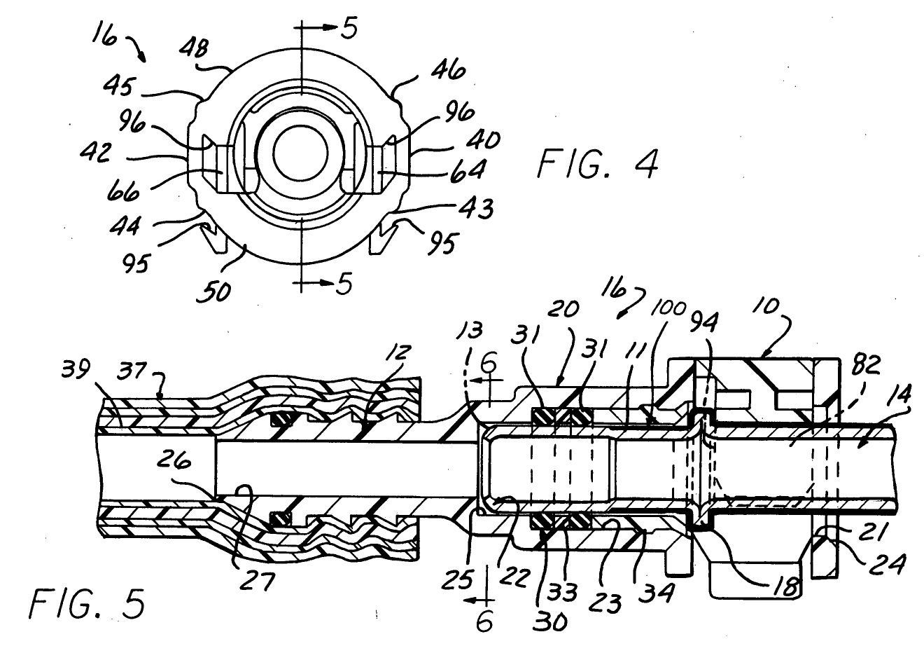

As shown in FIGS. 1, 3, and 4, the first end 24 of the housing 20 is formed with a pair of opposed, exterior flat surfaces 40 and 42. The flat surfaces 40 and 42 are diametrically opposed on the first end 24 and may be centrally located on each diametrical side of the first end 24. The adjacent surfaces of the housing 20 to one side of the flat surfaces 40 and 42 form an opposed pair of lock surfaces or flats, such as a first flat 43 and a second flat 44. A second pair of flats 45 and 46 are formed on the housing 20 or the other side of the flat surfaces 40 and 42. The flats 43 and 44 extend axially a short distance from the first end 24 of the housing 20. Opposed surfaces 48 and 50 of the first end 24 of the housing 20 between the flats 43 and 44 and the flats 45 and 46 have a generally arcuate shape as shown in FIGS. 3 and 4. Apertures 49 and 51 are formed respectively in each surface 48 and 50. The apertures 49 and 51 are aligned to form a transverse bore extending through the first end 24 of the housing 20 which is disposed in communication with the first bore portion 21 in the housing 20.

The retainer 10 is described hereafter by way of example only as other radially-displaceable retainer designs having side locking projections may also be employed. Alternately, the housing 20 can be reconfigured to receive an axial-type retainer.

The retainer 10 is formed of a one-piece body of a suitable plastic, such as nylon, for example, and has an end wall 62 formed of a generally curved or arcuate shape, by way of example only, and first and second spaced side legs 64 and 66. The side legs 64 and 66 extend generally parallel to each other from opposite ends of the end wall 62. Further, each side leg 64 and 66 has an outer end 72, although it is also possible to connect the side legs 64 and 66 at a lower end by an arcuate, flap-like, member.

A pair of projections 70 extend along the length of the retainer 10 between opposed side edges of the side legs 64 and 66, respectively. The projections 70 are located adjacent the outer end 72 of each leg 64 and 66. The projections 70 engage surfaces on the housing 20 to position the retainer 10 in the shipping position shown in FIG. 3, or in the fully inserted, latched position shown in FIGS. 4 and 5.

Further, a pair of outward extending lock tabs or edges 74 are formed adjacent the end wall 62 on each side leg 64 and 66. The lock tabs 74 engage notches 76 formed in the housing 20 when the retainer 10 is fully inserted into the housing 20. The lock tabs 74 are off-set from the center of the length of each of the side legs 64 and 66 so as to be located generally closer to one side edge of the retainer 10 than the opposed side edge. Similarly, the notches 76 formed in the housing 20 are closer to the first end of the housing 24. This provides a visual indication of a proper orientation of the retainer 10 in the housing 20 to ensure that the retainer 10 is correctly positioned to lock the connector component 14 in the housing 20.

As shown in FIGS. 2, 5, and 6 the retainer 10 includes a radially flange receiving means 80 which is preferably carried as an integral, one-piece part of the retainer 10. The radial flange receiving means 80 includes first and second depending arms 82 and 84 which extend from a boss or enlargement 86 integrally formed on the inner surface of the end wall 62 of the retainer 10. An inverted, U-shaped slot 88 is formed on the inner surfaces of the arms 82 and 84 and the boss 86 which is sized to snugly conform to the outer diameter of the tubular portion 11 of the endform component 14. The outer ends 91 of each of the arms 82 and 84 are angled or tapered to act as a guide surface to assist in sliding movement of the arms 82 and 84 over the tubular end 11 of the endform component 14.

As shown in FIGS. 1 and 2, each of the arms 82 and 84 extends from one side end contiguous with a first side end 90 of the retainer 10 to an opposed side end which is spaced from with a second side end 92 of the retainer 10. This forms a slot or recess 94 within the interior of the legs 64 and 66 and the end of the arms 82 and 84. The recess 94, shown in FIGS. 5 and 6, is positioned to receive the annular flange 18 on the endform 14 only when the endform 14 is fully inserted into the housing 20. This ensures a fully seated, sealed connection between the endform or conduit 14 and the housing 20 while completely locking the endform or component 14 in the housing 20.

As shown in FIGS. 1, 2, 3 and 4, the projections 70 on the legs 64 and 66 of the retainer 10 are formed with an angled hook-like shape terminating in a tip 95. The tip 95 is disposed at an acute, upturned angle with respect to the corresponding legs 64 and 66.

Similarly, as shown in FIGS. 3 and 4, the grooves 40′ and 42′ are formed in the interior of the flat surfaces 40 and 42, respectively, and include a recess or notch 96 at one end which is shaped complimentary to the shape of the tip 95 of the projection 70 on each of the legs 64 and 66 of the retainer 10. In this manner, pull out of the retainer 10 from the housing 20 is resisted by the interlocking tips 95 on the legs 64 and 66 of the retainer 10 which are seated within the notches 96 in the grooves 40′ and 42′ in the housing 20 as shown in the partially inserted, shipping position of the retainer 10 in FIG. 3. The flats or lock edges 44 and 46 are disposed at an angle complimentary to the acute angle of the tips 95 on the legs 64 and 66 of the retainer 10. This enables interlock of the tips 95 with the flats 44 and 46 resists pull out of the retainer 10 from the housing 20 from the fully latched position shown in FIG. 4.

The hook shaped tips 95 on the legs 64 and 66 of the retainer 10 in conjunction with the grooves 40′ and 42′ in the housing 20 also provide, a distinct, “avalanche effect” snap action of the retainer 10 in the housing 20. The grooves 40′ and 42′ in the housing 20 are formed in generally planar flat surfaces. The inner surfaces force the ends 72 of the legs 64 and 66 laterally inward toward each other when the retainer 10 is inserted into the housing 20. When the tips 95 clear one edge of the grooves 40′ and 42′, the resilient nature of the legs 64 and 66 snaps the ends 72 and the tips 95 laterally outward to create an “avalanche effect” which provides a distinct tactile feedback to the user indicating that the retainer has lockingly engaged the housing 20 in either the partially inserted position shown in FIG. 3 or the fully inserted position shown in FIG. 4.

It should be noted that further insertion force on the retainer 10 moving the retainer 10 from the partially inserted position shown in FIG. 3 to the fully inserted position shown in FIG. 4 again causes the end 72 of the legs 64 and 66 to be urged laterally inward when the tips 95 of the legs 64 and 66 slide along the lower portion of the inner surfaces. When the tips 95 clear the outer end of the inner surfaces, the legs 64 and 66 spring laterally outward in a distinct “avalanche effect” manner. The lower ends of the grooves 40′ and 42′ are angled to enable the tips 95 to slide out of the grooves 40′ and 42′ toward the fully latched position.

The retainer 10 can be first be installed on the housing 20 in a shipping or storage position as shown in FIG. 3. In this position, the projections 70 on the side legs 64 and 66 of the retainer 10 snap into and engage the longitudinally extending grooves 40′ and 42′.

Further insertion of the retainer 10 through the aligned apertures 49 and 51 in the housing 20 causes the ends 72 of the legs 64 and 66 to pass along the lower portion of the inner surfaces of the flat surfaces 40 and 42 until the tips 95 clear the ends of the surfaces and then snap outward exteriorly of the outer surface of the first end 24 of the housing 20 as shown in FIG. 4. In this fully inserted position of the endform component 14 in the first component 12, the annular flange 18 on the endform 14 is situated ahead the arms 82 and 84 of the retainer 10. This position represents the fully latched position in which the endform 14 is fully seated in and lockingly engaged with the first component 12. The full insertion of the retainer 10 into the housing 20 also provides visible indication of the fully locked connection of the endform 14 and the first component 12.

It should be noted that if the endform 14 is not fully engaged or seated within the housing 20, the annular flange 18 on the endform 14 will not be properly situated within the transverse bore in the housing 20 to slidably receive the arms 82 and 84 in the retainer 10. If the annular flange 18 on the endform 14 is at any position other than shown in phantom in FIG. 5, the arms 82 and 84 on the retainer 10 will contact the annular flange 18. Since the spacing between the inner surfaces of the legs 82 and 84 is less than the outer diameter of the annular flange 18, the retainer 10 cannot be moved to the fully inserted position thereby providing an indication of an incomplete seating or mounting of the end portion 11 of the endform 14 in the housing 20.

As shown in FIGS. 5 and 6, a protective, corrosion resistant layer 100, such as a polymeric, i.e., Nylon, coating, for example only, is applied or otherwise disposed or fixed on the exterior surface of the endform 14. The corrosion resistant layer 100 extends from an end 102, which is spaced from the tip end 13 of the endform 14, away from the tip end 13 along the length of the endform or conduit 14.

The layer 100 may be applied to the endform 14 in a variety of different application methods, such as deposition, extruding, etc. The layer 100 may also be applied over the entire exterior surface of the endform 14 extending from and including the tip end 13 and then removed from a portion of the tip end 11 of the endform 14 to form the first end 102. Thus, the layer 100 may be disposed about a constant outer diameter tip end 11 of the endform 14.

Alternately, to minimize the exterior diameter of the overall connector housing 20, a first portion 104 of the endform 14 extending from the tip end 13 to an annular edge 106 has a first outer diameter which is completely devoid of the protective layer 100. An intermediate annular transition zone 108 extends from the edge 106 to a second portion of the tip 11 of the endform 14 which has a smaller outer diameter than the outer diameter of the first bare portion 104. This enables the layer 100 to be fixed to the exterior surface of the endform 14 and form an outer diameter substantially equal to the outer diameter of the bare or uncovered first portion 104 of the endform 14 extending from the tip end 13 to the edge 106.

The smaller outer diameter portion 110 of the endform 14 may have a thinner wall thickness than the wall thickness of the first portion 104 or a smaller inner diameter than the inner diameter of the first portion 104 as shown in FIG. 6. This minimizes the amount of reduction in endform inner diameters in order to maximize fluid flow through the fluid coupling.

During insertion of the tip portion 11 of the endform 14 through the open end 24 of the housing 20 and into the interior bore 22 of the housing 20, the tip end 13 and the bare end portion 104 of the endform 14 slide through the top hat 34 and the one or more seal means or elements 30 until the endform 14 reaches the fully inserted position shown in FIGS. 5 and 6 in the connector 12 enabling movement of the retainer 10 to the fully latched position. In this fully latched position, the one or more seal means or elements 30 contact the bare exterior surface of the endform 14 to provide a reliable fluid seal between the rigid connector housing 20 and the rigid end portion 104 of the endform 14 without contacting the protective layer 100. As shown in FIGS. 5 and 6, the layer 100 remains completely spaced from and does not contact the seal elements 30. This minimizes the risk of fluid flow paths forming between the inner surface of the protective layer 100 and the exterior surface of the endform 14.

Thus, there has been described a unique fluid coupling which minimizes fluid leaks by providing a fluid seal between the endform and a surrounding connector housing of the fluid coupling directly between the rigid housing and a bare, non-protective coated end portion of the endform. At the same time, the construction of the quick connector and its components does not require modification. Further, the outer and inner diameters of the endform remain substantially unchanged to minimize any change in fluid flow capacity through the coupling. Further, the entire fluid coupling can be made reliably as an electrically conductive coupling or joint since a conductive path can be formed at any position along the bare, uncoated end portion of the endform and the surrounding connector housing. Further, only the minimum necessary length of the endform lacks the protective material layer.

What is claimed is:

1. A fluid coupling comprising:
a housing having a bore extending from one end;
a seal mounted in the bore;
an endform having a tip portion extending from a tip end, and a retainer engagement surface spaced from the tip end;
a retainer movable with respect to the housing into engagement with the retainer engagement surface on the endform to latch the endform to the housing; and
a protective layer on an exterior surface of the endform extending from an end spaced from the tip end of the endform and defining a bare exterior surface on the tip portion of the endform, whereby the bare exterior surface of the endform directly contacts the seal in the bore in the housing.

2. The fluid coupling of claim 1 wherein:
the tip portion of the endform has a first portion devoid of the protective layer formed with a first outer diameter, and a second portion, extending axially from the first portion, having a smaller second outer diameter underneath the protective layer.

3. The fluid coupling of claim 2 wherein:
a transition surface is formed at the juncture of the first and second portions of the tip portion on the endform.

4. The fluid coupling of claim 3 wherein:
the protective layer is formed on the exterior surface of the endform with the end of the protective layer contiguous with the transition surface and the protective layer disposed over the outer diameter of the second portion of the tip portions.

5. The fluid coupling of claim 4 wherein:
the outer diameter of the protective layer on the second portion of the tip portion is substantially identical to the first outer diameter of the first portion of the tip portion.

6. The fluid coupling of claim 1 wherein in the seal comprises:
a resilient seal member.

7. The fluid coupling of claim 1 wherein the seal comprises:
at least one resilient seal member and a rigid seal member. both disposed in direct contact with the bare exterior surface of the end form.

8. The fluid coupling of claim 1 wherein in the seal comprises:
a pair of spaced resilient seal members; and
a rigid seal member disposed between the pair of seal members, all of the seal members disposed in direct contact with the bare exterior surface of the end form.
